(19) United States
(12) Patent Application Publication
(10) Pub. No.: US 2007/0012802 A1
(43) Pub. Date: Jan. 18, 2007

(54) HAND-HELD SPRAYER FOR HORTICULTURE AND THE LIKE

(75) Inventor: Angel Ma Espeso Ansola, Motrico (Guipuzkoa) (ES)

Correspondence Address: DARBY & DARBY P.C., P. O. BOX 5257, NEW YORK, NY, 10150-5257, US

(73) Assignee: GOIZPER, S. COOP., Antzuola (Guipuzkoa) (ES)

(21) Appl. No.: 11/531,110

(22) Filed: Sep. 12, 2006

Related U.S. Application Data
(63) Continuation of application No. PCT/ES04/00295, filed on Jun. 23, 2004.

(30) Foreign Application Priority Data
Apr. 30, 2004 (ES) 200401040

(51) Int. Cl. A62C 11/00

(52) U.S. Cl. 239/333; 239/375

(57) ABSTRACT

The sprayer is characterised by an intermediate body consisting of a single injection-moulded part which comprises an external casing and an internal tubular element such that the external casing is connected to the upper portion of the container and the internal tubular body receives in its interior the pump piston, the upper front portion of the intermediate body having a recess for receiving a valve communicating with the chamber of the spray nozzle and a cylindrical enlargement for receiving the body for conveying liquid thereto; said intermediate sprayer body being extended in the portion remote from the nozzle by an enlargement for supporting the hand, and said sprayer body being closed at its upper portion by a single injection-moulded cover.

### CROSS-REFERENCE TO RELATED APPLICATIONS

This application is a Continuation of International Application No. PCT/ES2004/000295, filed Jun. 23, 2004, which claims priority under 35 U.S.C. §119 to Spanish Application No. 200401040 filed Apr. 30, 2004, which is hereby incorporated by reference in its entirety.

### DESCRIPTION

The present invention relates to a hand-held sprayer which is particularly applicable to horticulture and the like.

The object of the present invention is to disclose a sprayer which is simple in construction, economical to produce and reliable and durable.

The structure of the sprayer according to the present invention is very simple, combining a hand-operated pump with a container of considerable size having an overall delivery capacity combined with a compressed liquid outlet which is controlled by a trigger-actuated slide valve and a spray nozzle having a single orifice with coaxial distribution of liquid. The hand-operated pump has a considerable diameter which is slightly smaller than the body supporting the assembly of actuating valve, spray nozzle and grip, which may be screwed to the liquid-carrying container.

One of the characteristics of the sprayer according to the present invention is its formation by a very small number of parts having geometrically very simple characteristics that allow very low production costs. For example, the main body is basically formed by a single part incorporating the cylinder of the hand pump in a single part which also includes the housing for the slide valve and the support for the spray nozzle. This not only allows an air cylinder of maximum size, which allows a reduction in the pumping time required to achieve the working pressure, but also the production of the sprayer body from a minimum of parts, which helps to reduce production costs.

To sum up, the sprayer is of the type comprising a container for the spray liquid, with a hand pump for supplying compressed air to the interior of the container, an outlet nozzle and an intermediate valve for controlling the passage of liquid to the outlet nozzle, and is characterised by the production of the body of the sprayer as a single injection moulding that exhibits an external casing and an internal tubular element, such that the external casing is connected with a press-fit to the upper portion of the container and the internal tubular body receives, in its interior, the piston of the hand pump of the sprayer, the upper front portion of said body comprising a housing for receiving a horizontal slide valve actuated by a trigger to control spraying; as well as a cylindrical enlargement for receiving the tubular horizontal body of said nozzle. The sprayer body is extended at the portion remote from the nozzle by an enlargement having ergonomic characteristics to facilitate the location of the hand at the moment of use.

The body receives, in its upper portion, a cover which engages with the tubular element of the body, with the ergonomic rear projection thereof and with the tubular horizontal body of the nozzle, its connection being made by clipping at various points of its periphery.

To assist understanding, some drawings of a sprayer produced in accordance with the present invention are appended as explanatory, non-limiting examples.

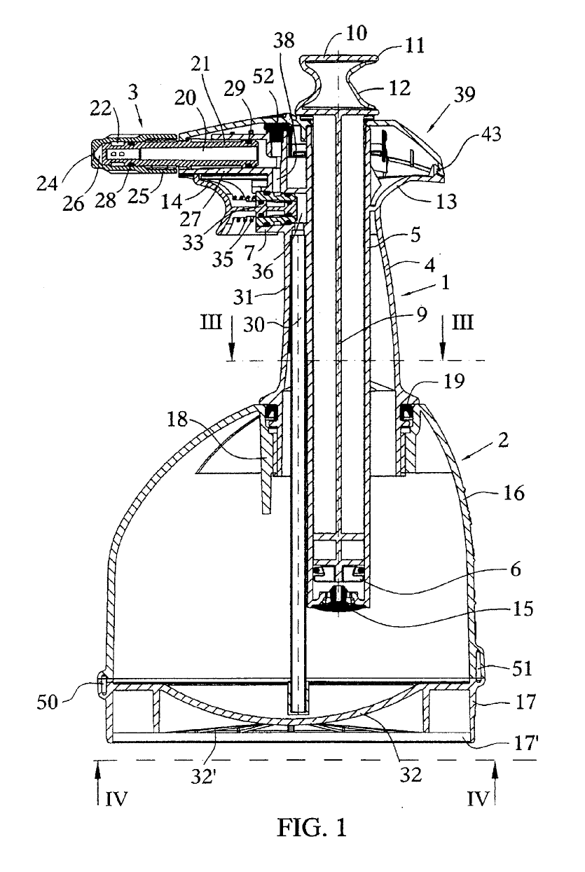

FIG. 1 is a complete section of a sprayer produced according to the present invention.

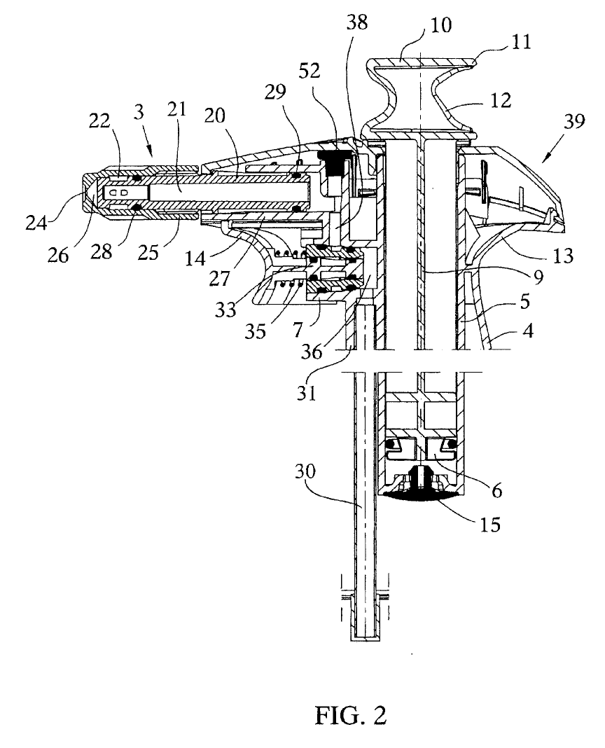

FIG. 2 is a section in detail of the control and spray head.

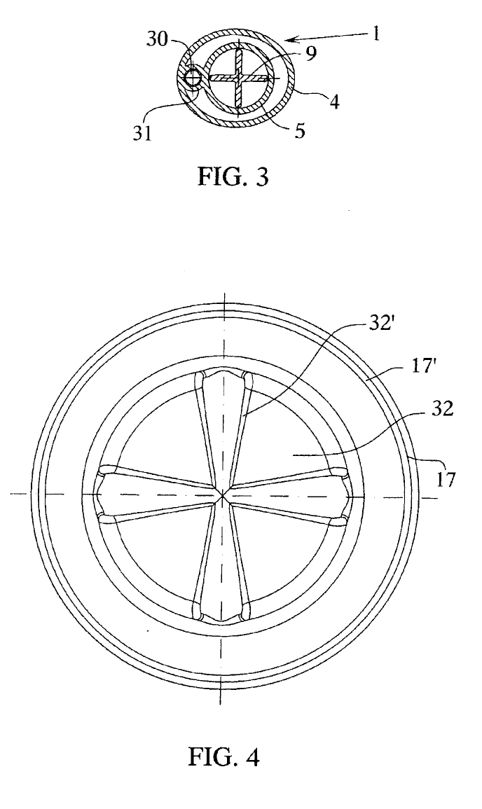

FIG. 3 is a cross-section through the sectional plane indicated in FIG. 1.

FIG. 4 is a view of the lower face of the spraying device.

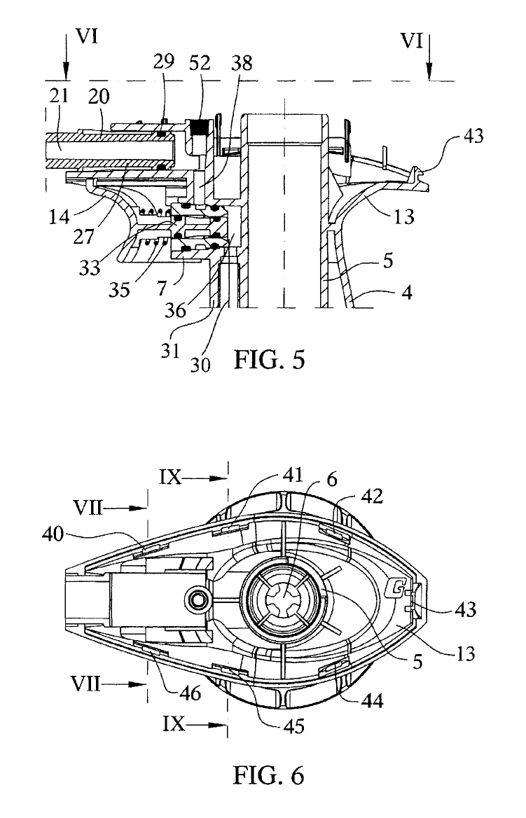

FIG. 5 is a view on an enlarged scale showing the zone of actuation by a trigger and of passage of liquid toward the nozzle.

FIG. 6 is a plan view of the sprayer with the upper cover removed.

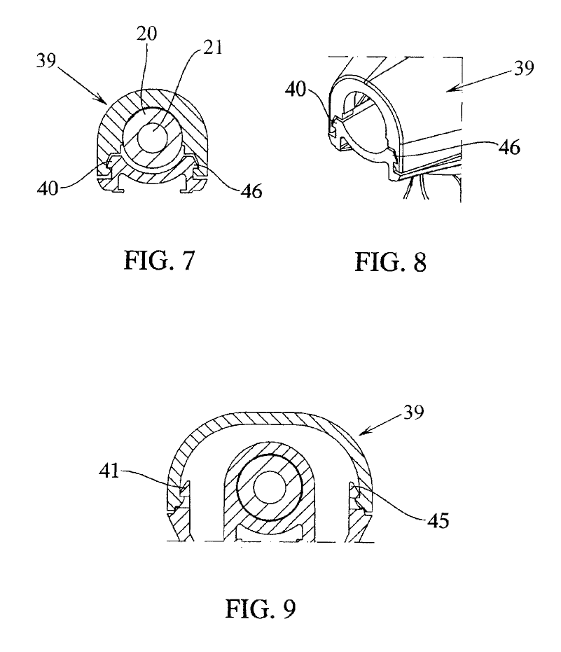

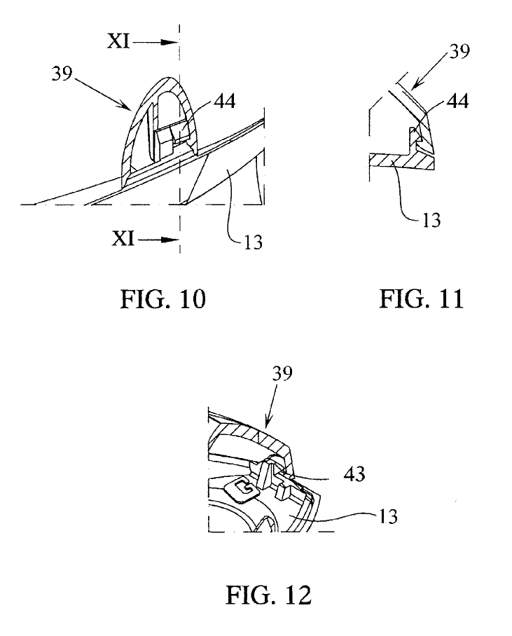

FIG. 7 to 12 show details of the fastening of the upper cover of the sprayer by clipping.

As shown in the figures, the design of the sprayer according to the present invention mainly comprises an intermediate body 1, the lower container 2 for holding the liquid that is to be sprayed and a nozzle assembly 3 for spraying the liquid. The body 1 is produced in a single part and comprises an external casing 4 and an internal body 5 which is the cylinder of the air compression pump, in the interior of which there slides the compression piston 6, said body 1 similarly comprising the housing 7 in the front portion for receiving the manual control valve and the front extension 27 for receiving the tubular element 20 for the intake of liquid to the nozzle. The piston 6 is connected to a long actuating rod 9 which, at the upper portion, comprises a handhold 10 moulded into an anatomical shape, together with the actual rod and the piston forming a single assembly of the pump which is displaceable within the cylinder 5. The rod 9 preferably has a cross-shaped cross-section, as shown in FIG. 3. The structure of the upper end 10 is suitable for the ergonomic gripping of the displaceable assembly of the air compression pump comprising, for example, the rear portion 11 which is optionally elongated to allow easy manual gripping, and the form of the intermediate collar 12 is similarly suitable for the improved gripping thereof. Said unitary body 1 similarly comprises an enlargement 13 to allow ergonomic, convenient and firm gripping of the sprayer with a single hand which in this way by one portion grips the sprayer by the body 1 with the hand located on the enlargement 13 and having the possibility of simultaneously actuating the front trigger 14 that actuates the slide valve to allow passage of the liquid.

The cylinder 5 will usually comprise the valve assembly to allow the admission of air from the exterior to the interior of the cylinder and from there to the container 2, only a resilient nonreturn valve 15 of conventional design having been shown in the lower portion of the tubular element 5 for the sake of clarity.

The container 2 is made up of two component parts, one being the upper part 16 and the other, the lower part 17, comprising a cylindrical skirt with a lower support rim 17′ that defines a stable lower surface to allow horizontal placement of said receiver and which defines the central portion 32 in the form of a spherical cap with lower ribs 32′. The lower part 17 is coupled to the lower part of the container 2 by locating pins such as 50 and 51 and a rigid connection, for example by adhesive, a welding system and the like.

The part 16 forming the upper portion of the container 2 has an internal enlargement 18 adapted for the press-fitting of the lower portion of the intermediate body 4 of the sprayer. A seal 19 ensures that said container is hermetically sealed.

The nozzle assembly 3 comprises a liquid-conveying internal cylindrical body 20 which is provided with a coaxial orifice 21 and comprises, in its front portion, radial apertures 22 that communicate via grooves with the single front outlet 24 for the spray jet. Said body 20 is surrounded at the front by the cap 25 which comprises said outlet aperture 24 and defines, in its front portion, the cavity 26 where the jets of liquid are combined and turbulently mixed before issuing through the aperture 24. The actual body 20 is press-fitted within the cylindrical enlargement 27 of the intermediate body and carries O-ring seals 28 and 29 in the region of its ends to produce a tight seal from said external cap 25 and cylindrical enlargement 27.

The liquid held in the container 2 passes to the nozzle body 3 via a tubular element 30 which is press-fitted at the top into a recess 31 produced in the intermediate body 4 of the sprayer 1 and, at the bottom, reaches to the vicinity of the bottom 32 of the container 2.

The passage of the liquid between the tubular conduit 30 and the nozzle assembly 3 is controlled by a slide valve 33 of which the displacement is controlled by the manually actuated trigger 14 which, in turn, is subjected to the opposing action of a helical spring 35. In this way, by overcoming the action of the spring 35, as in the position shown in FIGS. 1 and 2, the slide valve 33 which has longitudinal grooves occupies a position in which the liquid originating from the tube 30 can reach an internal chamber 36 and, along the slide valve 33, can pass to a communicating chamber 38 in which there opens the end of the orifice 21 of the nozzle body 20.

An upper unitary cover 39 closes the entire top portion of the sprayer body, a plurality of latching points being provided for this purpose, as shown in FIG. 6, in which they are designated by the numerals 40, 41, 42, 43, 44, 45 and 46, the number and disposition of said latching points varying widely. As shown in the details in FIG. 7 to 12, hook-shaped projections in a male/female disposition are provided at all the latching points, and it will be appreciated that other types of latch-type detent profiles may be produced without departing from the scope of the present invention.

The actual cover 39 presses a stopper 52 for access to the chamber 38 connecting the slide valve 33 and the tubular element 20 for conveying liquid to the nozzle.

Owing to the described design, the sprayer according to the present invention may be produced simply and economically with a very small number of parts, and this reduces the production costs and also results in a significant increase in the reliability of operation and durability.

1. Hand-held sprayer for horticulture and the like, of the type comprising a container for the spray liquid, with a hand pump for supplying compressed air to the interior of the container, an outlet nozzle and a hand-operated valve for controlling the passage of liquid to the outlet nozzle, characterised by the production of an intermediate body of the sprayer as a single injection moulding that exhibits an external casing and an internal tubular element, such that the external casing is connected to the upper portion of the liquid container and the internal tubular body receives, in its interior the piston of the hand pump, the upper front portion of said intermediate body comprising a housing for receiving a horizontal slide valve for communication with the chamber communicating with the spray nozzle and a cylindrical enlargement receiving the tubular body for conveying liquid thereto; said intermediate sprayer body being extended at the portion remote from the nozzle by an enlargement for the location of the hand during use thereof and said sprayer body being closed at its upper portion by a single similarly injection moulded cover which, by its rear portion, completes the abutment enlargement for the hand grip and, by its front portion, presses a stopper which closes the chamber for passage of liquid toward the nozzle and surrounds the tubular body for conveying liquid thereto.

2. Hand-held sprayer for horticulture and the like according to claim 1, characterised in that the air pump piston is formed as a single part with its rod and an upper grip part of anatomical shape for the easy gripping thereof for the pumping operation.

3. Hand-held sprayer for horticulture and the like according to claim 1, characterised in that the nozzle assembly is introduced by press-fitting and is fixed by the cover in a surrounding recess of the upper portion of the sprayer body and, by the other end, is closed by an external cap which is screwed thereon and comprises an outlet orifice to which the compressed liquid travels via an axial orifice of said cylindrical body and a system of radial apertures and extreme grooves of the actual cylindrical body.

4. Hand-held sprayer for horticulture and the like according to claim 1, characterised in that the upper closure cover of the intermediate sprayer body is joined by crimping by multiple couplings of its lower base which coincide with mating couplings of the rim of the intermediate body.

5. Hand-held sprayer for horticulture and the like according to claim 1, characterised in that the horizontal passage valve has an intermediate grooved structure with O-ring seals at its ends and is integral with the actual actuating trigger forming a single part.

6. Hand-held sprayer for horticulture and the like according to claim 1, characterised in that the container carries a large internal cylindrical extension that is directed inwardly from its upper orifice and is provided with an internal region for receiving, by press-fitting, the lower end of the sprayer body.
